(19) United States
(12) Patent Application Publication
(10) Pub. No.: US 2025/0385474 A1
(43) Pub. Date: Dec. 18, 2025

(54) Electrical System with a Connector Having a Shorting Spring

(71) Applicant: TE Connectivity Solutions GmbH, Schaffhausen (CH)

(72) Inventors: Galen M. Martin, Middletown, PA (US); Bert Bergner, Bensheim (DE)

(73) Assignee: TE Connectivity Solutions GmbH, Schaffhausen (CH)

(21) Appl. No.: 18/741,394

(22) Filed: Jun. 12, 2024

(51) Int. Cl. H01R 13/703; H01R 13/424

(52) U.S. Cl. CPC H01R 13/7031; H01R 13/424

(57) ABSTRACT

An electrical system includes a connector and a mating connector matable with the connector. The connector has a housing with terminals and a shorting spring disposed in the housing. The shorting spring abuts a pair of terminals in a first set of terminals and connects the pair of terminals in a connected position. The shorting spring is in the connected position when the connector and the mating connector are in an unmated state. The first set of terminals are connected with mating terminals of the mating connector in a mated state; the first set of terminals are connected to each other in the mated state by at least one of the shorting spring and a short connecting the mating terminals.

### FIELD OF THE INVENTION

The present invention relates to an electrical system and, more particularly, to an electrical system with a connector having a shorting spring.

### BACKGROUND

Connectors can be used to form electrical connections to transmit power, signals, and/or data. Data connections, for example across a data bus, can be connected through a series of connectors that are connected by cables. In an existing configuration of a data bus, circuitry for connecting the bus is housed within mating connectors that are matable with the connectors; in this configuration, the data bus is only connected when the connectors are connected with the mating connectors, but is interrupted when the connectors are not connected. Further, the connectors that are used in these data connection arrangements often have a large format and are specifically configured for various applications, which increases manufacturing complexity and cost.

### SUMMARY

An electrical system includes a connector and a mating connector matable with the connector. The connector has a housing with terminals and a shorting spring disposed in the housing. The shorting spring abuts a pair of terminals in a first set of terminals and connects the pair of terminals in a connected position. The shorting spring is in the connected position when the connector and the mating connector are in an unmated state. The first set of terminals are connected with mating terminals of the mating connector in a mated state; the first set of terminals are connected to each other in the mated state by at least one of the shorting spring and a short connecting the mating terminals.

### BRIEF DESCRIPTION OF THE DRAWINGS

The invention will now be described by way of example with reference to the accompanying Figures, of which:

FIG. 1 is a perspective view of a connector according to an embodiment;

FIG. 2 is a sectional perspective view of a housing of the connector;

FIG. 3 is a perspective view of a pair of terminals and a shorting spring of the connector;

FIG. 4 is a sectional perspective view of the connector;

FIG. 5A is a front schematic view of a connector according to another embodiment;

FIG. 5B is a front schematic view of a connector according to another embodiment;

FIG. 6 is a sectional top view of an electrical system including the connector and a mating connector in an unmated state;

FIG. 7 is a sectional top view of the connector and the mating connector in a mated state; and

FIG. 8 is a schematic diagram of communication network including a plurality of connectors with a plurality of mating connectors, the connectors connected in a daisy chain configuration.

### DETAILED DESCRIPTION OF THE EMBODIMENT(S)

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. In addition, in the following detailed description, for purposes of explanation, numerous specific details are set forth in order to provide a thorough understanding of the disclosed embodiments. However, it is apparent that one or more embodiments may also be implemented without these specific details.

Throughout the specification, directional descriptors are used such as “longitudinal”, “width”, and “vertical”. These descriptors are merely for clarity of the description and for differentiation of the various directions. These directional descriptors do not imply or require any particular orientation of the disclosed elements.

Throughout the drawings, only one of a plurality of identical elements may be labeled in a figure for clarity of the drawings, but the detailed description of the element herein applies equally to each of the identically appearing elements in the figure.

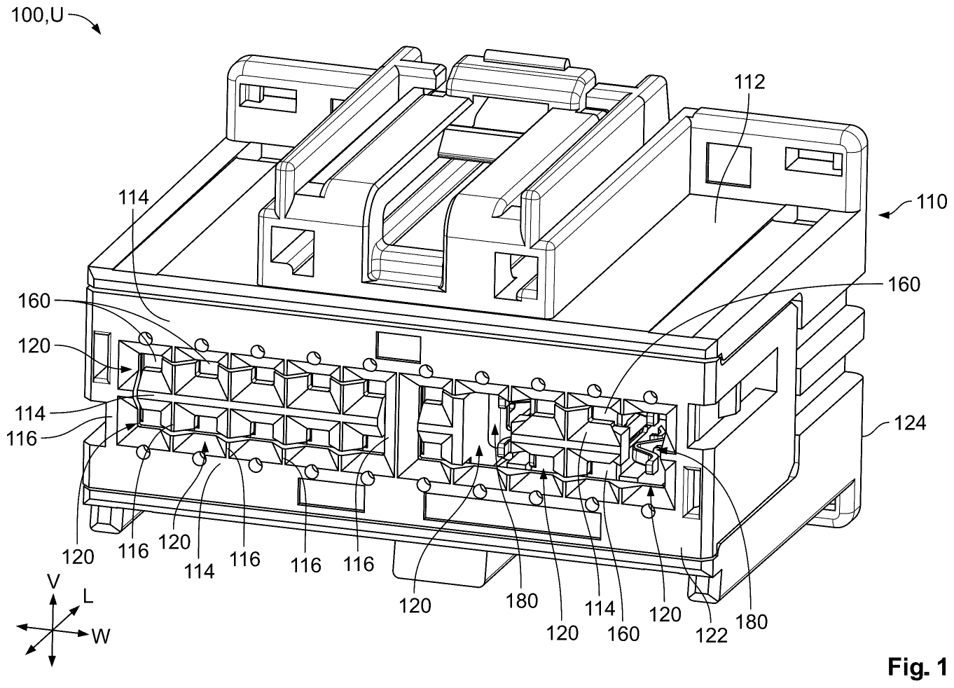

A connector 100 according to an embodiment is shown in FIG. 1. The connector 100 includes a housing 110, a plurality of terminals 160 disposed in the housing 110, and a plurality of shorting springs 180 disposed in the housing 110.

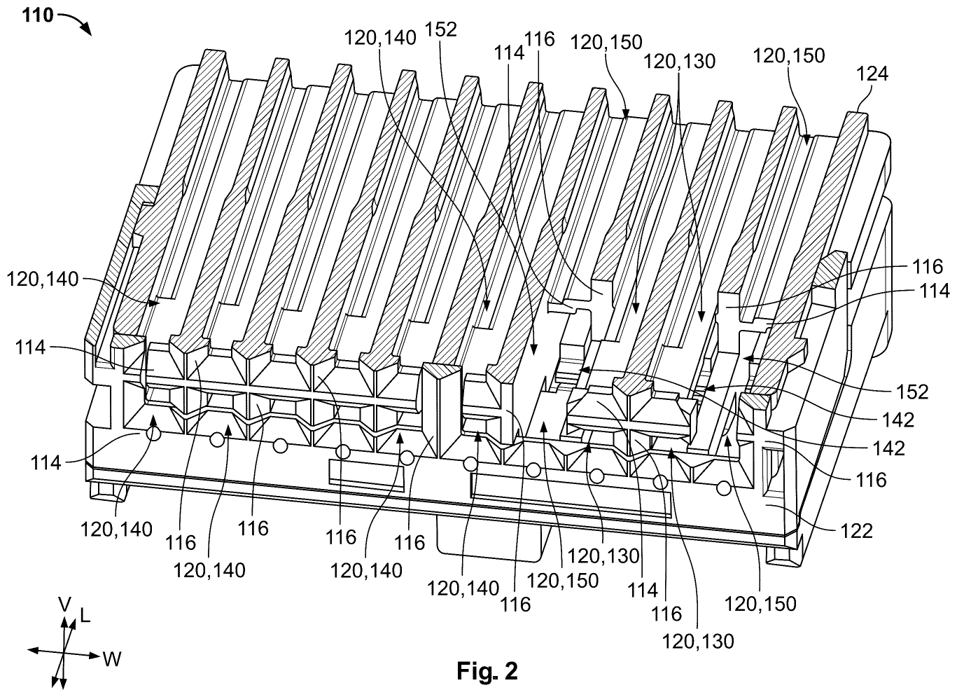

The housing 110, as shown in FIGS. 1 and 2, has a body 112 with a plurality of lateral walls 114 and a plurality of vertical walls 116. The lateral walls 114 extend along a width direction W and the vertical walls 116 extend along a vertical direction V perpendicular to the width direction W. The lateral walls 114 and vertical walls 116 define a plurality of terminal receiving passageways 120 between them.

As shown in FIGS. 1 and 2, the terminal receiving passageways 120 extend through the body 112 from a housing mating end 122 to a housing connecting end 124 along a longitudinal direction L that is perpendicular to the width direction W and the vertical direction V. The terminal receiving passageways 120 are each defined by a pair of lateral walls 114 of the housing 110 that are opposite each other in the vertical direction V and a pair of vertical walls 116 of the housing 110 that are opposite each other in the width direction W. The terminal receiving passageways 120, in the embodiment shown in FIG. 2, include a plurality of first passageways 130, a plurality of second passageways 140, and a plurality of third passageways 150.

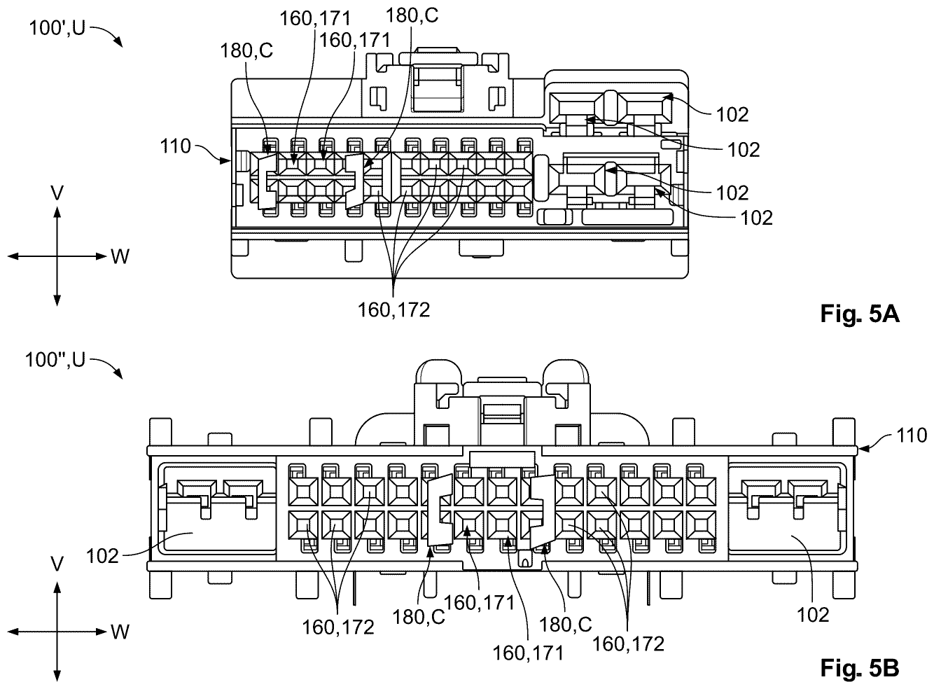

In the shown embodiment, the housing 110 is formed with the terminal receiving passageways 120 in a pair of rows. As shown in FIG. 2, the first passageways 130 are positioned in both rows and are between two pairs of third passageways 150. The second passageways 140 are in both rows and are separated from the first passageways 130 by one of the pairs of third passageways 150. In the shown embodiment, the housing 110 has twenty positions or twenty terminal receiving passageways 120 with two rows each having ten terminal receiving passageways 120; each row has two first passageways 130, six second passageways 140, and two third passageways 150. In other embodiments, as described in greater detail below with respect to FIGS. 5A and 5B, the number of terminal receiving passageways 120 and the sizes and arrangements of the types of passageways 130, 140, 150 can be different in other embodiments.

The first passageways 130, the second passageways 140, and the third passageway 150 all differ from each other due to the removal of portions of the lateral walls 114 and the vertical walls 116 in some of the terminal receiving passageways 120. As shown in FIG. 2, a portion of one of the vertical walls 116 is removed to form a lateral opening 142 in each row between each of the first passageways 130 and one of the third passageways 150. A portion of one of the lateral walls 114 is removed to form a vertical opening 152 between the third passageways 150 aligned in the vertical direction V in the two rows. The lateral walls 114 and the vertical walls 116 do not have removed portions in the second passageways 140; the lateral walls 114 and the vertical walls 116 in the second passageways 140 extend from the housing mating end 122 to the housing connecting end 124.

The housing 110 is formed from an electrically insulative material, such as a plastic. In the shown embodiment, the housing 110 is formed from multiple pieces that are assembled together to form the lateral walls 114 and vertical walls 116 defining the terminal receiving passageways 120 as described above. In other embodiments, the housing 110 can be monolithically formed in a single piece with the features described herein.

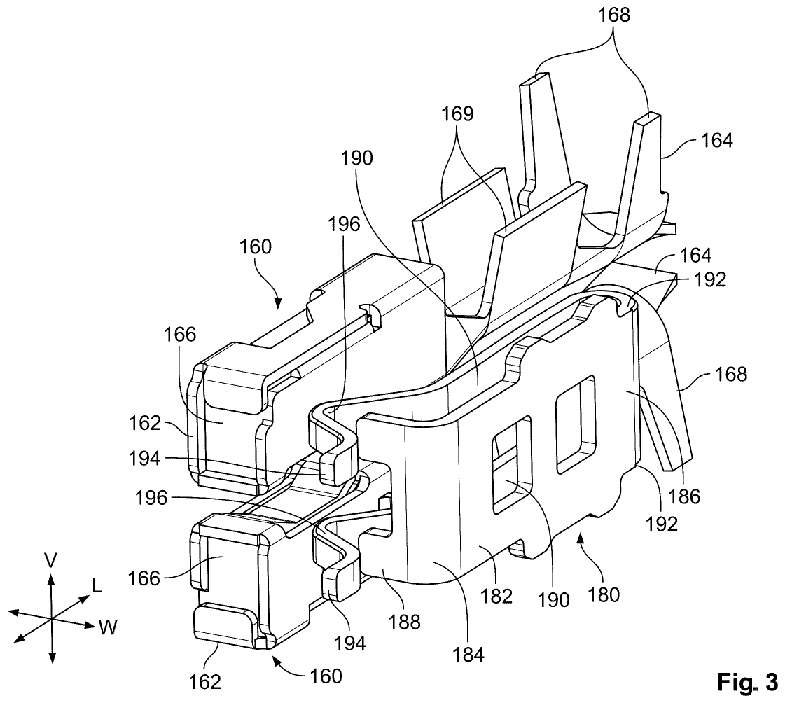

The terminals 160, as shown in detail in FIG. 3, each extend from a terminal mating end 162 to a terminal connecting end 164 along the longitudinal direction L. In the shown embodiment, the terminals 160 each have a receptacle 166 at the terminal mating end 162, a pair of first crimping wings 168 at the terminal connecting end 164, and a pair of second crimping wings 169 between the receptacle 166 and the first crimping wings 168 along the longitudinal direction L. The receptacle 166 is adapted to receive and mate with a pin to electrically connect with the pin. The first crimping wings 168 are capable of crimping to an insulation of a cable while the second crimping wings 169 crimp to a conductor of the cable to electrically connect the terminal 160 with the cable. In other embodiments, the terminals 160 may have different mating components than the receptacle 166 and may have different structures to connect to a cable instead of the crimping wings 168, 169.

The terminals 160 are formed of a conductive material, such as copper, aluminum, or stainless steel. In the shown embodiment, the terminals 160 are each monolithically formed in a single piece from the conductive material. In other embodiments, the terminals 160 may be formed in a plurality of separate pieces and assembled together to form the terminals 160 with the elements described herein.

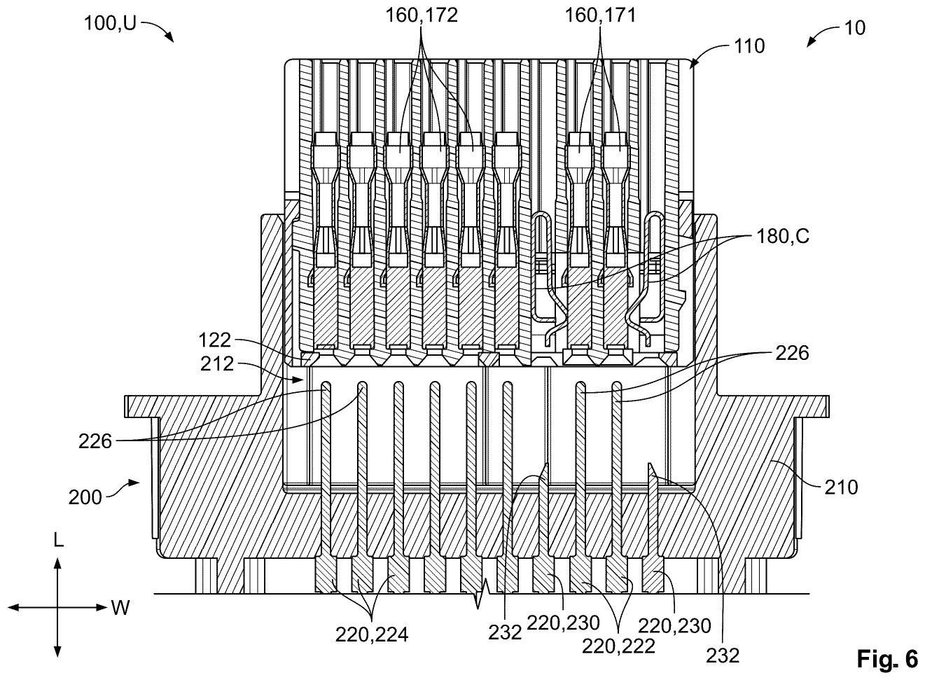

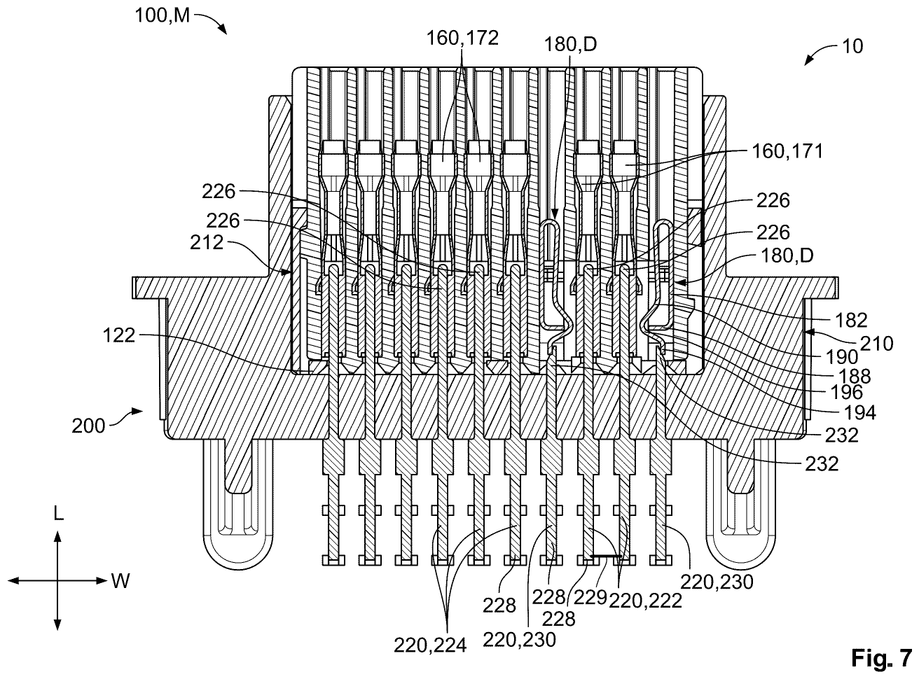

The shorting springs 180, as shown in FIG. 3, each have a base 182 and a pair of arms 190 extending from the base 182. The arms 190 are resiliently or elastically deflectable with respect to the base 182 between a connected position C and a deflected position D, described in greater detail below with reference to FIGS. 6 and 7.

As shown in FIG. 3, the base 182 extends from a first end 184 to a second end 186 along the longitudinal direction L. The base 182 has a stop 188 that extends from the first end 184 in the width direction W. In the shown embodiment, the stop 188 is bent from the first end 184 of the base 182.

The arms 190, as shown in FIG. 3, each extend from a connected end 192 to a free end 194 opposite the connected end 192 along the longitudinal direction L. The connected end 192 of each of the arms 190 is connected to the second end 186 of the base 182. The free end 194 of each of the arms 190 is not directly connected to the base 182 and, in the shown embodiment, protrudes beyond the first end 184 of the base 182 in the longitudinal direction L. The arms 190 each have a contact bend 196 between the connected end 192 and the free end 194 that is aligned with the stop 188 in the width direction W.

The shorting springs 180 are each formed of a conductive material, such as copper, aluminum, or stainless steel. In the shown embodiment, the shorting springs 180 are each monolithically formed in a single piece from the conductive material. In other embodiments, the shorting springs 180 may be formed in a plurality of separate pieces and assembled together to form the shorting springs 180 with the elements described herein.

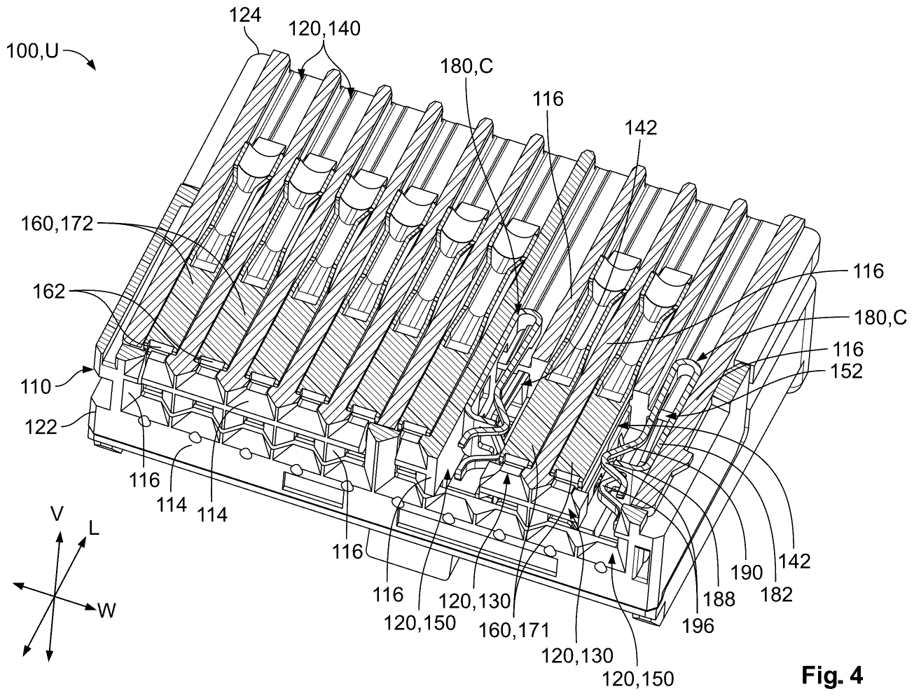

A method of assembling the connector 100 will now be described in greater detail primarily with reference to FIGS. 1 and 4.

First, the housing 110 of the connector 100 is provided. In an embodiment, the housing 110 can be an available type of housing that has a number of terminal positions at the terminal receiving passageways 120 used, for example, for power or signal transmission. In the initially provided housing 110, the terminal receiving passageways 120 may all be identical to one another and are each configured to receive one of the terminals 160 in the same manner.

In an embodiment, however, prior to inserting the terminals 160 and the shorting springs 180, the housing 110 is modified from the initial state in which the terminal receiving passageways 120 are all identical. As shown in FIG. 2 and described above, portions of some of the vertical walls 116 of the terminal receiving passageways 120 may be removed to form the lateral openings 142 between each of the first passageways 130 and one of the third passageways 150. Portions of some of the lateral walls 114 may be removed to form the vertical openings 152 between the third passageways 150. No portions of the lateral walls 114 or the vertical walls 116 are removed in the second passageways 140. The removal of the portions of the lateral walls 114 and the vertical walls 116 may be performed by any tools and any method commonly used in the art for modifying or removing rigid insulative materials. In another embodiment, for example, the housing 110 may be molded with the geometry shown in FIG. 2 including the lateral openings 142 and the vertical openings 152.

Once the housing 110 has been modified to have the first passageways 130, the second passageways 140, and the third passageways 150 that are different from one another, the terminals 160 are inserted into the terminal receiving passageways 120. As shown in FIG. 4, the terminals 160 include a first set of terminals 171 and a second set of terminals 172. The first set of terminals 171 are inserted into and positioned in the plurality of first passageways 130 of the terminal receiving passageways 120 in the housing 110. The second set of terminals 172 are inserted into and positioned in the plurality of second passageways 140 of the terminal receiving passageways 120 in the housing 110. In the shown embodiment, the terminals 160 in the first set of terminals 171 and the terminals 160 in the second set of terminals 172 are identical to one another.

As shown in FIG. 4, the terminal mating end 162 of each of the terminals 160 in both sets 171, 172 is positioned adjacent to the housing mating end 122. In the first passageways 130, a portion of each of the terminals 160 in the first set 171 is exposed through one of the lateral openings 142.

In an embodiment, the shorting springs 180 are then inserted into the third passageways 150, as shown in FIG. 4. In another embodiment, the shorting springs 180 can be inserted into the third passageways 150 before the terminals 160 are inserted. Each of the shorting springs 180 is fitted in one of the vertical openings 152 and is positioned in two of the third passageways 150. The base 182 of the shorting spring 180 abuts one of the vertical walls 116 of the housing 110 and the arms 190 face the first passageways 130, with the contact bends 196 of the arms 190 each positioned in one of the lateral openings 142.

With the connector 100 fully assembled and in an unmated state U, as shown in FIGS. 1 and 4, the shorting springs 180 are each in a connected position C. In the connected position C, the contact bends 196 of the arms 190 are each positioned in one of the lateral openings 142 and each abut one of the terminals 160 of the first set of terminals 171. The contact of the contact bends 196 with the terminals 160 in the first set of terminals 171 in the connected position C electrically connects each of the shorting springs 180 to two of the terminals 160 in the first set of terminals 171 and shorts or electrically connects two of the terminals 160 in the first set of terminals 171 to each other.

In an exemplary embodiment, the connector 100 can be used for a combination of power, signal, and data transfer over a data bus. In this embodiment, the terminals 160 in the second set of terminals 172 are used for the power and/or signal transmission. The terminals 160 in the first set of terminals 171 are used to connect the data bus. In the unmated state U of the connector 100 in which the shorting springs 180 are in the connected position C, the shorting springs 180 connect the terminals 160 in the first set of terminals 171 used for the data bus connection to maintain the data bus connection even while the connector 100 is unmated. In this embodiment, the cable connected to the terminals 160 in the first set of terminals 171 may be twisted pair cable. In this embodiment, the terminals 160 in the second set of terminals 172 are not connected to each other or to any external element in the unmated state U.

Forming the connector 100 in this manner, by modifying the housing 110 to have power, signal, and data connections within the harness of the housing 100, allows for greater flexibility in the connections formed by the connector 100 with few changes to the structure of the housing 110.

The connector 100 shown in FIGS. 1-4 is merely one exemplary embodiment of a connector 100 that can be modified to include the first set of terminals 171 that are connected or shorted by the shorting spring 180 and the second set of terminals 172 that are not connected in the unmated state U. In other embodiments, as shown for example in FIGS. 5A and 5B, the connector 100 can have a different number of positions corresponding to the number of terminal receiving passageways 120, can have different numbers of terminals 160 in the first set of terminals 171 and the second set of terminals 172, and may further include other types of connections. The connectors 100, 100′, 100″ shown and described herein are merely some examples of the arrangements of terminal receiving passageways 120, terminals 160, and shorting springs 180 within the scope of the present disclosure.

As shown in the embodiment of FIG. 5A, for example, a connector 100′ has the same number of terminals 160 in the first set of terminals 171, the same number of terminals 160 in the second set of terminals 171, and the same number of shorting springs 180 connecting the terminals 160 in the first set of terminals 171. The housing 110 is modified in the same manner as described above to accommodate these terminals 160 and shorting springs 180. The connector 100′ in this embodiment additionally includes larger passageways 102 positioned on a side of the housing 110 in the width direction W that receive terminals for other power and ground connections.

As shown in the embodiment of FIG. 5B, for example, a connector 100″ has a greater number of terminals 160 in the second set of terminals 172, but the same number of terminals 160 in the first set of terminals 171 and, correspondingly, the same number of shorting springs 180. The housing 110 is modified in the same manner as described above to accommodate these terminals 160 and shorting springs 180. In this embodiment, the first set of terminals 171 are positioned between the second set of terminals 172 and the larger passageways 102 that receive terminals for other power and ground connections are positioned on opposite sides of the terminals 171, 172 in the width direction W.

An electrical system 10 according to an embodiment is shown in FIGS. 6 and 7. The electrical system 10 includes the connector 100 described above and a mating connector 200 that is matable with the connector 100.

The mating connector 200, as shown in FIGS. 6 and 7, includes a mating housing 210 and a plurality of mating terminals 220 in the mating housing 210. The mating housing 210 in the shown embodiment has a mating cavity 212. The mating terminals 220 include a plurality of first mating terminals 222 and a plurality of second mating terminals 224. Each of the first mating terminals 222 and the second mating terminals 224 has a mating end 226 positioned in the mating cavity 212 and an opposite terminal end 228 positioned outside of the mating cavity 212.

The mating terminals 220 further include a plurality of third mating terminals 230 that extend through the mating housing 210, as shown in FIGS. 6 and 7. The third mating terminals 230 are shorter than the first mating terminals 222 and the second mating terminals 224 along the longitudinal direction L. The third mating terminals 230 each have an abutting end 232 positioned in the mating cavity 212 and an opposite terminal end 228 positioned outside of the mating cavity 212. In the shown embodiment, the abutting end 232 of each of the third mating terminals 230 is sloped or angled.

The connector 100 in the electrical system 10 is movable from the unmated state U shown in FIG. 6 to a mated state M shown in FIG. 7 in which the connector 100 is mated with the mating connector 200. In the unmated state U shown in FIG. 6, in the connector 100 as described above, the shorting springs 180 are in the connected position C and connect the terminals 160 in the first set of terminals 171.

The housing mating end 122 is positioned in the mating cavity 212 and the connector 100 is moved into the mating connector 200 along the longitudinal direction L to transition from the unmated state U to the mated state M shown in FIG. 7. As the connector 100 moves into the mated state M, the mating ends 226 of the first mating terminals 222 and the second mating terminals 224 enter the terminal mating ends 162 of the terminals 160 and electrically connect with the terminals 160. In the mated state M, the first mating terminals 222 are mated with the terminals 160 in the first set of terminals 171 and the second mating terminals 224 are mated with the terminals 160 in the second set of terminals 172.

In the shown embodiment, as the connector 100 moves into the mated state M, and after the mating terminals 222, 224 connect with the terminals 160, each of the third mating terminals 230 contacts one of the shorting springs 180. The abutting end 232 of the third mating terminal 230 moves into abutment with the free end 194 of one of the arms 190 of the shorting spring 180 during insertion along the longitudinal direction L. As the connector 100 is further inserted along the longitudinal direction L, the free end 194 of the arm 190 moves along the slope of the abutting end 232 of the third mating terminal 230, which deflects the arms 190 away from the terminals 160 in the first set of terminals 171 in the width direction W. The third mating terminals 230 contact the arms 190 of the shorting spring 180 and move the shorting spring 180 from the connected position C to a deflected position D shown in FIG. 7, in which the arms 190 and the contact bends 196 on each arm 190 are deflected away from the terminals 160 in the first set of terminals 171. The deflection of the shorting spring 180 by the third mating terminals 230 during insertion of the connector 100 to the mated state M moves the contact bends 196 out of contact with the first set of terminals 171 and disconnects the shorting springs 180 from the first set of terminals 171. In the deflected position D corresponding to the mated state M, each of the shorting springs 180 is spaced apart from the terminals 160 in the first set of terminals 171 and does not connect the first set of terminals 171.

In the mated state M shown in the embodiment of FIG. 7, the terminals 160 in the first set of terminals 171 are connected by the first mating terminals 222 and not by the shorting spring 180. The first mating terminals 222 may be connected to one another by a short 229, for example a copper trace, at a printed circuit board or another short outside of the connector 100 that maintains the connection between the terminals 160 in the first set of terminals 171 in the mated state M. In the shown embodiment, the third mating terminals 230 are connected to ground and, while connected to the shorting springs 180, form a grounding connection with the shorting springs 180 that can serve as an electromagnetic shield for the connection between the first set of terminals 171 and the first mating terminals 222.

In another embodiment, the mating connector 200 either does not have the third mating terminals 230 that contact and deflect the shorting springs 180 or the third mating terminals 230 do not deflect the shorting springs 180 in the mated state M. In this embodiment, the shorting springs 180 are not deflected to the deflected state D and remain in contact with the terminals 160 in the first set of terminals 171 in the connected position C, as shown in FIG. 6, in the unmated state U and through insertion of the connector 100 into the mating connector 200 to the mated state M. The shorting springs 180 in this embodiment connect the terminals 160 in the first set of terminals 171 in both the unmated state U and the mated state M. The short 229 of the first mating terminals 222 may be also be present in this embodiment and may provide a redundancy by which both the shorting springs 180 are connected to the first set of terminals 171 and the short 229 connects the first mating terminals 222 as shown in FIG. 7 to additionally maintain the connection between the first set of terminals 171 in the mated state M.

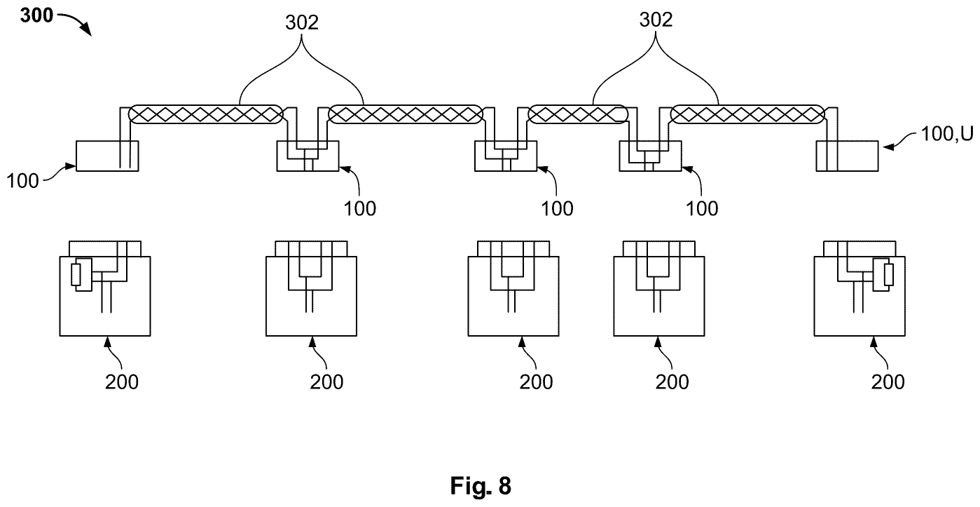

As shown in FIG. 8, the connector 100 and the mating connector 200 according to the embodiments described above can be used in a communication network 300. The schematic diagram of FIG. 8 shows a plurality of connectors 100 connected in a daisy chain configuration by a plurality of twisted pair cables 302. The twisted pair cables 302 connected through the first set of terminals 171 in the connectors 100 form a data bus, as described above. In the unmated state U of the connectors 100 with the mating connectors 200 shown in FIG. 8, the connectors 100 maintain the connection through the daisy chained data bus by the connection of the shorting springs 180 with the terminals 160 in the first set of terminals 171 as described above. When the connectors 100 are each plugged into one of the mating connectors 200 to the mated state M, the shorting springs 180 are disconnected from the terminals 160 in an embodiment and the connection through the daisy chained data bus is maintained by the connection between the terminals 160 in the first set of terminals 171 and the first mating terminals 220. Alternatively, the shorting springs 180 can remain connected to the terminals 160 in the mated state M and the connection between the first set of terminals 171 and the first mating terminals 220 provides a redundancy, increasing a reliability of the bus connection. The configuration of the connector 100 and the mating connector 200 thus allows a data bus connection to be maintained, within the harness of the housing 110 of the connector 100, both in the unmated state U and in the mated state M.

What is claimed is:

1. An electrical system, comprising:
a connector including a housing, a plurality of terminals disposed in the housing, and a shorting spring disposed in the housing, the terminals include a first set of terminals and a second set of terminals, the shorting spring abuts a pair of terminals in the first set of terminals and connects the pair of terminals in a connected position; and
a mating connector matable with the connector and having a plurality of mating terminals, the shorting spring is in the connected position when the connector and the mating connector are in an unmated state, the pair of terminals in the first set of terminals are connected with a pair of first mating terminals of the mating terminals in a mated state of the connector and the mating connector, the pair of terminals in the first set of terminals are connected to each other in the mated state by at least one of the shorting spring and a short connecting the first mating terminals.

2. The electrical system of claim 1, wherein the shorting spring is deflectable between the connected position and a deflected position, the shorting spring in the deflected position is spaced apart from the pair of terminals in the first set of terminals and does not connect the pair of terminals.

3. The electrical system of claim 1, wherein the terminals in the second set of terminals are not connected to each other.

4. The electrical system of claim 1, wherein the connector has a housing with a plurality of terminal receiving passageways, the terminals are each disposed in one of the terminal receiving passageways and the shorting spring is disposed in a pair of the terminal receiving passageways.

5. The electrical system of claim 4, wherein the first set of terminals are positioned in a plurality of first passageways of the terminal receiving passageways and the second set of terminals are positioned in a plurality of second passageways of the terminal receiving passageways, the first passageways are different than the second passageways.

6. The electrical system of claim 5, wherein the terminal receiving passageways are each defined by a pair of lateral walls and a pair of vertical walls of the housing.

7. The electrical system of claim 6, wherein the shorting spring is positioned in a pair of third passageways of the terminal receiving passageways, the third passageways are different than the first passageways and the second passageways.

8. The electrical system of claim 7, wherein a portion of one of the vertical walls has a lateral opening between each of the first passageways and one of the third passageways, the shorting spring abuts the pair of terminals in the first set of terminals in the lateral openings.

9. The electrical system of claim 7, wherein a portion of one of the lateral walls has a vertical opening between the third passageways, the shorting spring is positioned in the vertical opening.

10. The electrical system of claim 1, wherein the terminals in the first set of terminals and the terminals in the second set of terminals are identical.

11. The electrical system of claim 2, wherein the shorting spring has a base and a pair of arms that are deflectable with respect to the base between the connected position and the deflected position.

12. The electrical system of claim 2, wherein the shorting spring is disconnected from the pair of terminals in the deflected position, the shorting spring is in the deflected position when the connector and the mating connector are in the mated state.

13. The electrical system of claim 2, wherein the mating terminals include a plurality of second mating terminals that mate with the second set of terminals in the mated state.

14. The electrical system of claim 2, wherein the mating terminals include a third mating terminal that contacts the shorting spring and moves the shorting spring from the connected position to the deflected position during movement of the connector and the mating connector from the unmated state to the mated state.

15. The electrical system of claim 14, wherein the pair of terminals in the first set of terminals are connected by the first mating terminals and not by the shorting spring in the mated state.

16. The electrical system of claim 14, wherein the third mating terminal forms a grounding connection with the shorting spring in the mated state.

17. The electrical system of claim 1, wherein the shorting spring is in the connected position in the mated state.

18. The electrical system of claim 17, wherein the short connects the first mating terminals that are connected with the pair of terminals in the first set of terminals in the mated state.

19. The electrical system of claim 1, wherein the connector is connected to a twisted pair cable and the connection between the pair of terminals in the first set of terminals is part of a data bus.
